(19) United States
(12) Patent Application Publication
(10) Pub. No.: US 2026/0281882 A1
(43) Pub. Date: Sep. 17, 2026

(54) ELECTRONIC DEVICE FOR CONTROLLING SCAN BASED ON NETWORK STATUS ANALYSIS USING MACHINE LEARNING AND OPERATING METHOD THEREOF

(71) Applicant: SAMSUNG ELECTRONICS CO., LTD., Suwon-si (KR)

(72) Inventors: Dongchul MA, Suwon-si (KR); Daekyung KIM, Suwon-si (KR); Sungbo PARK, Suwon-si (KR); Yeji WOO, Suwon-si (KR); Rakyoung YOON, Suwon-si (KR); Byungho HONG, Suwon-si (KR)

(73) Assignee: SAMSUNG ELECTRONICS CO., LTD., Suwon-si (KR)

(21) Appl. No.: 19/555,008

(22) Filed: Mar. 3, 2026

Related U.S. Application Data
(63) Continuation of application No. PCT/KR2025/019739, filed on Nov. 26, 2025.

(30) Foreign Application Priority Data
Mar. 17, 2025 (KR) 10-2025-0033826
Apr. 7, 2025 (KR) 10-2025-0044938

(51) Int. Cl. H04W 48/16; H04W 36/00

(52) U.S. Cl. CPC H04W 48/16; H04W 36/0061

(57) ABSTRACT

An electronic device includes: at least one processor including processing circuitry; and memory storing instructions, wherein the instructions, when executed by the at least one processor individually or collectively, cause the electronic device to: determine whether a radio-access technology (RAT) being used in a network to which the electronic device is connected is changed from a first RAT to a second RAT which is lower than the first RAT, based on determining that the RAT is changed to the second RAT, determine, using an artificial intelligence (AI) model, whether the electronic device enters a zone.

### CROSS-REFERENCE TO RELATED APPLICATIONS

This application is a continuation application of International Application No. PCT/KR2025/019739 designating the United States, filed on Nov. 26, 2025, in the Korean Intellectual Property Receiving Office and claiming priority to Korean Patent Application No. 10-2025-0033826, filed on Mar. 17, 2025, and Korean Patent Application No. 10-2025-0044938, filed on Apr. 7, 2025, in the Korean Intellectual Property Office, the disclosures of which are incorporated by reference herein in their entireties.

### BACKGROUND

### Field

The present disclosure relates to an electronic device for controlling a scan based on network status analysis using machine learning and an operating method of the electronic device.

### Description of Related Art

Radio-access technology (RAT) may change depending on the network status (e.g., signal strength or the like). For example, when the network status is bad, RAT may be changed from fifth generation (5G) (e.g., a new radio (NR)) to fourth generation (4G) (e.g., long-term evolution (LTE)). When RAT is changed from higher RAT to lower RAT, a RAT scan may be performed to recover back to the higher RAT. Rapid recovery of RAT may be required to provide better network services to users.

The above information may be presented as related art to help with the understanding of the disclosure. No arguments or decisions are raised to whether any of the above description is applicable as the prior art related to the present disclosure.

### SUMMARY

According to an aspect of the disclosure, an electronic device includes: at least one processor including processing circuitry. The electronic device includes memory storing instructions. The instructions, when executed by the at least one processor individually or collectively, cause the electronic device to: determine whether a radio-access technology (RAT) being used in a network to which the electronic device is connected is changed from a first RAT to a second RAT which is lower than the first RAT. The instructions, when executed by the at least one processor individually or collectively, cause the electronic device to::based on determining that the RAT is changed to the second RAT, determine, using an artificial intelligence (AI) model, whether the electronic device enters a zone. The AI model is trained to determine whether the electronic device enters or leaves the zone causing a change of the RAT by using information related to a quality of the second RAT as an input to the AI model. The instructions, when executed by the at least one processor individually or collectively, cause the electronic device to: based on determining that the electronic device leaves the zone, perform a scan to change the RAT to the first RAT based on cell frequency information of the first RAT.

According to an aspect of the disclosure, an operation method of an electronic device includes: determining whether a radio-access technology (RAT) being used in a network to which the electronic device is connected is changed from a first RAT to a second RAT which is lower than the first RAT. The operation method includes: based on determining that the RAT is changed to the second RAT, determining, using an artificial intelligence (AI) model, whether the electronic device enters a zone. The AI model is trained to determine whether the electronic device enters or leaves the zone causing a change of the RAT by using information related to a quality of the second RAT as an input to the AI model. The operation method includes: based on determining that the electronic device leaves the zone, performing a scan to change the RAT to the first RAT based on cell frequency information of the first RAT.

According to an aspect of the disclosure, a non-transitory computer-readable storage medium storing one or more computer programs. The one or more computer programs comprising instructions. The instructions, when executed by at least one processor individually or collectively, cause an electronic device to: determine whether a radio-access technology (RAT) being used in a network to which the electronic device is connected is changed from a first RAT to a second RAT which is lower than the first RAT. The instructions, when executed by the at least one processor individually or collectively, cause the electronic device to: based on determining that the RAT is changed to the second RAT, determine, using an artificial intelligence (AI) model, whether the electronic device enters a zone. The AI model is trained to determine whether the electronic device enters or leaves the zone causing a change of the RAT by using information related to a quality of the second RAT as an input to the AI model. The instructions, when executed by the at least one processor individually or collectively, cause the electronic device to: based on determining that the electronic device leaves the zone, perform a scan to change the RAT to the first RAT based on cell frequency information of the first RAT.

According to an aspect of the disclosure, an electronic device includes: at least one processor including processing circuitry. The electronic device includes memory storing instructions. The instructions, when executed by the at least one processor individually or collectively, cause the electronic device to: determine whether a radio-access technology (RAT) being used in a network to which the electronic device is connected is changed from a first RAT to a second RAT which is lower than the first RAT. The instructions, when executed by the at least one processor individually or collectively, cause the electronic device to: based on determining that the RAT is changed to the second RAT, determine, based on an artificial intelligence (AI) model, whether the electronic device enters a zone. The AI model is trained to determine whether the electronic device enters or leaves the zone causing a change of the RAT by using information related to a quality of the second RAT as an input to the AI model. The instructions, when executed by the at least one processor individually or collectively, cause the electronic device to: based on determining that the electronic device enters the zone, stop a scan for the electronic device to change from the RAT to the first RAT.

According to an aspect of the disclosure, an operation method of an electronic device includes: determining whether a radio-access technology (RAT) being used in a network to which the electronic device is connected is changed from a first RAT to a second RAT which is lower than the first RAT. The operation method includes: based on determining that the RAT is changed to the second RAT, determining, based on an artificial intelligence (AI) model, whether the electronic device enters a zone. The AI model is trained to determine whether the electronic device enters or leaves the zone causing a change of the RAT by using information related to a quality of the second RAT as an input to the AI model. The operation method includes: based on determining that the electronic device enters the zone, stopping a scan for the electronic device to change from the RAT to the first RAT.

According to an aspect of the disclosure, a non-transitory computer-readable storage medium storing one or more computer programs. The one or more computer programs comprising instructions. The instructions, when executed by at least one processor individually or collectively, cause an electronic device to: determine whether a radio-access technology (RAT) being used in a network to which the electronic device is connected is changed from a first RAT to a second RAT which is lower than the first RAT. The instructions, when executed by the at least one processor individually or collectively, cause the electronic device to: based on determining that the RAT is changed to the second RAT, determine. based on an artificial intelligence (AI) model, whether the electronic device enters a zone. The AI model is trained to determine whether the electronic device enters or leaves the zone causing a change of the RAT by using information related to a quality of the second RAT as an input to the AI model. The instructions, when executed by the at least one processor individually or collectively, cause the electronic device to: based on determining that the electronic device enters the zone, stop a scan for the electronic device to change from the RAT to the first RAT.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an electronic device in a network environment, according to various embodiments;

FIG. 2 is a block diagram illustrating an electronic device in a network environment including a plurality of cellular networks, according to an embodiment;

FIG. 3 is a block diagram illustrating an operation of an electronic device, according to an embodiment;

FIG. 4 is a flowchart illustrating an operation of an electronic device, according to an embodiment;

FIG. 5 is a diagram illustrating an artificial intelligence (AI) model according to an embodiment;

FIGS. 6 and 7 are diagrams illustrating training data that is input to an AI model, according to an embodiment;

FIG. 8 is a diagram illustrating the performance of an AI model, according to an embodiment;

FIG. 9 is a diagram illustrating training data based on sensor data, according to an embodiment;

FIG. 10 is an example of a diagram illustrating an operation of an electronic device, according to an embodiment; and

FIG. 11 is a flowchart illustrating an operation of an electronic device, according to an embodiment.

### DETAILED DESCRIPTION

Hereinafter, embodiments will be described in detail with reference to the accompanying drawings. When describing the embodiments with reference to the accompanying drawings, like reference numerals refer to like elements and any repeated description related thereto will be omitted.

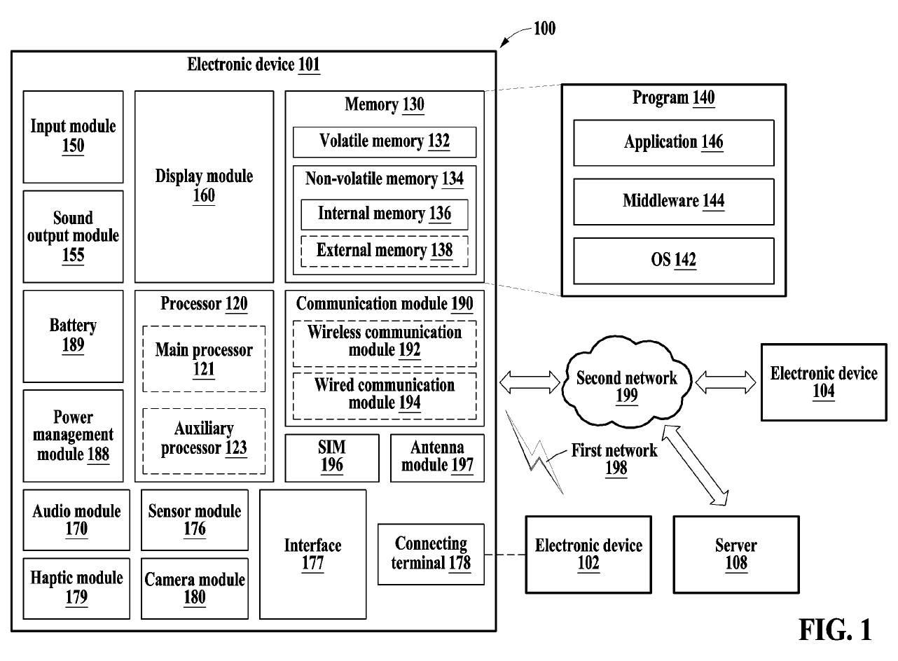

FIG. 1 is a block diagram illustrating an electronic device 101 in a network environment 100, according to one or more embodiments. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computation. According to an embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 that includes a communication processor (CP) and/or other processors described below, but not include an application processor (AP). According to an embodiment, the processor 120 may include a main processor 121 (e.g., a central processing unit (CPU) or the AP), or an auxiliary processor 123 (e.g., a graphics processing unit (GPU), a neural processing unit (NPU), an image signal processor (ISP), a sensor hub processor, or the CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence model processing. An artificial intelligence model may be generated through machine learning. The machine learning may be performed by, for example, the electronic device 101, in which artificial intelligence is performed, or performed via a separate server (e.g., the server 108). Learning algorithms may include, but are not limited to, for example, supervised learning, unsupervised learning, semi-supervised learning, or reinforcement learning. The artificial intelligence model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the above examples, but the present disclosure is not limited to the above examples or their combinations. The AI model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a record. The receiver may be used to receive an incoming call. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to sense a touch, or a pressure sensor adapted to measure the intensity of force incurred by the touch.

The audio module 170 may convert a sound into an electrical signal or vice versa. According to an embodiment, the audio module 170 may obtain the sound via the input module 150 or output the sound via the sound output module 155 or an external electronic device (e.g., the electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., a LAN or a wide area network (WAN)). These various types of communication modules may be implemented as a single component (e.g., a single chip), or may be implemented as multiple components (e.g., multiple chips) separate from each other. The wireless communication module 192 may identify or authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a fourth generation (4G) network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to embodiments, the antenna module 197 may include a mmWave antenna module. According to an embodiment, the mmWave antenna module may include a PCB, an RFIC disposed on a first surface (e.g., a bottom surface) of the PCB or adjacent to the first surface and capable of supporting a designated high-frequency band (e.g., a mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an embodiment, all or some of operations to be executed at the electronic device 101 may be executed at one or more external electronic devices (e.g., the external devices 102 and 104, or the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To this end, cloud computing, distributed computing, mobile edge computing (MEC), or client-server computing technology may be used, for example. The electronic device 101 may provide ultra-low-latency services using, e.g., distributed computing or MEC. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

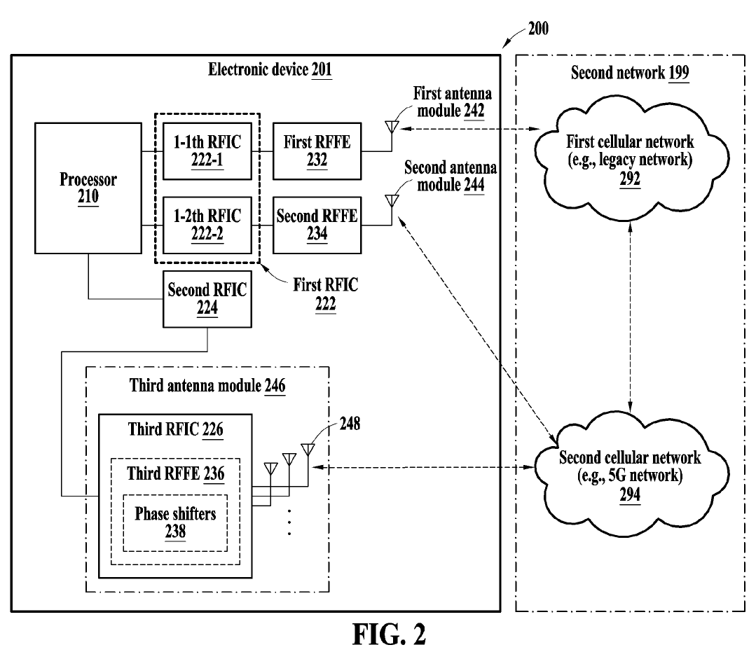

FIG. 2 is a block diagram illustrating an electronic device in a network environment including a plurality of cellular networks, according to an embodiment.

Referring to FIG. 2, an electronic device 201 (e.g., the electronic device 101 of FIG. 1) may include a processor 210 (e.g., the processor 120 of FIG. 1 or a CP), a 1-1th radio frequency integrated circuit (RFIC) 222-1, a 1-2th RFIC 222-2, a second RFIC 224, a first radio frequency front end (RFFE) 232, a second RFFE 234, a first antenna module 242, a second antenna module 244, and a third antenna module 246. Depending on embodiments, the 1-1th RFIC 222-1 and the 1-2th RFIC 222-2 may be implemented as one RFIC 222. The second network 199 may include a first cellular network 292 (e.g., a legacy network) and a second cellular network 294 (e.g., a 5G network). The electronic device 201 may further include at least one of the components described with reference to FIG. 1, and the second network 199 may further include at least one other network. In an embodiment, the second RFIC 224 may be omitted or included as part of a third RFIC 226. In an embodiment, the processor 210 may not include or correspond to an AP.

According to an embodiment, the 1-1th RFIC 222-1, the 1-2th RFIC 222-2, the second RFIC 224, the first RFFE 232, and the second RFFE 234 of FIG. 2 may be included in the communication module 190 (e.g., the wireless communication module 192) of FIG. 1, and the first antenna module 242, the second antenna module 244, and the third antenna module 246 of FIG. 2 may be included in the antenna module 197 of FIG. 1.

According to an embodiment, the processor 210 may establish a communication channel of a band to be used for wireless communication with the first cellular network 292 and support legacy network communication through the established communication channel. The first cellular network 292 may be, for example, a legacy network including a second generation (2G) network, a third generation (3G) network, a 4G network, or a long-term evolution (LTE) network. The processor 210 may establish a communication channel corresponding to a first band (e.g., about 6 gigahertz (GHz) to about 60 GHz) ((or a 5G standard frequency range (FR) 2 (e.g., 24.25 GHz to 52.6 GHz)) among bands to be used for wireless communication with the second cellular network 294 and may support 5G network communication through the established communication channel. The second cellular network 294 may be a 5G network defined by a third generation partnership project (3GPP). The processor 210 may establish a communication channel corresponding to a second band (e.g., about 6 GHz or less) ((or a 5G standard FR1 (e.g., 410 megahertz (MHz) to 7.125 GHz)) among bands to be used for wireless communication with the second cellular network 294 and may support 5G network communication through the established communication channel.

According to an embodiment, during transmission, the 1-1th RFIC 222-1 (or the first RFIC 222) may convert a baseband signal generated by the processor 210 into a radio frequency (RF) signal of a frequency band (e.g., about 700 MHz to about 3 GHz) to be used in the first cellular network 292. During reception, an RF signal may be received or acquired from the first cellular network 292 via the first antenna module 242 and may be preprocessed through the first RFFE 232. The 1-1th RFIC 222-1 (or the first RFIC 222) may convert the preprocessed RF signal into a baseband signal such that the signal may be processed by the processor 210.

According to an embodiment, during transmission, the 1-2th RFIC 222-2 (or the first RFIC 222) may convert a baseband signal generated by the processor 210 into an RF signal (hereinafter, referred to as a “5G Sub6 RF signal”) of a Sub6 band (e.g., about 6 GHz or less) to be used in the second cellular network 294. During reception, the 5G Sub6 RF signal may be received or acquired from the second cellular network 294 via the second antenna module 244 and may be preprocessed through the second RFFE 234. The 1-2th RFIC 222-2 (or the first RFIC 222) may convert the preprocessed 5G Sub6 RF signal into a baseband signal such that the signal may be processed by the processor 210.

According to an embodiment, the third RFIC 226 may convert a baseband signal generated by the processor 210 into an RF signal (hereinafter, referred to as a “5G Above6 RF signal”) of a 5G Above6 band (e.g., about 6 GHz to about 60 GHz) to be used in the second cellular network 294. During reception, the 5G Above6 RF signal may be received or acquired from the second cellular network 294 via the third antenna module 246 (e.g., an antenna 248) and may be preprocessed through a third RFFE 236. The third RFIC 226 may convert the preprocessed 5G Above6 RF signal into a baseband signal such that the signal may be processed by the processor 210. In an embodiment, the third RFFE 236 may be formed as part of the third RFIC 226.

According to an embodiment, the electronic device 201 may include the second RFIC 224, separate from or at least as part of the third RFIC 226. In this case, the second RFIC 224 may convert a baseband signal generated by the processor 210 into an RF signal (hereinafter, referred to as an “IF signal”) of an intermediate frequency band (e.g., about 9 GHz to about 11 GHz) and may transmit the IF signal to the third RFIC 226. The third RFIC 226 may convert the IF signal into a 5G Above6 RF signal. During reception, the 5G Above6 RF signal may be received or acquired from the second cellular network 294 via the third antenna module 246 (e.g., the antenna 248) and may be converted into an IF signal by the third RFIC 226. The second RFIC 224 may convert the IF signal into a baseband signal such that the signal may be processed by the processor 210.

According to an embodiment, at least one of the first antenna module 242 or the second antenna module 244 may be omitted or combined with another antenna module to process RF signals of a plurality of corresponding bands.

In an embodiment, the third RFIC 226 and the antenna 248 may be disposed on the same substrate to form the third antenna module 246. For example, the processor 120 may be disposed on a first substrate (e.g., a main PCB). In this example, the third RFIC 226 may be disposed on a partial area (e.g., a bottom surface) of a second substrate (e.g., a sub PCB) separate from the first substrate, and the antenna 248 may be disposed on another partial area (e.g., a top surface) of the second substrate (e.g., the sub PCB), to form the third antenna module 246. The third RFIC 226 and the antenna 248 may be disposed on the same substrate, and accordingly, it is possible to reduce a length of a transmission line between the third RFIC 226 and the antenna 248. This may reduce, for example, the loss (e.g., attenuation) of a signal in a high frequency band (e.g., about 6 GHz to about 60 GHz) used for 5G network communication due to a transmission line. Accordingly, the electronic device 201 may enhance the quality or speed of communication with the second cellular network 294 (e.g., a 5G network).

According to an embodiment, the antenna 248 may be formed as an antenna array including a plurality of antenna elements that may be used for beamforming. In this case, the third RFIC 226 may include, for example, a plurality of phase shifters 238 corresponding to the plurality of antenna elements as a portion of the third RFFE 236. During transmission, each of the plurality of phase shifters 238 may convert a phase of a 5G Above6 RF signal to be transmitted to the outside (e.g., a base station of a 5G network) of the electronic device 201 through a corresponding antenna element. During reception, each of the plurality of phase shifters 238 may convert a phase of a 5G Above6 RF signal received from the outside (e.g., the base station of the 5G network) through the corresponding antenna element into the same or substantially the same phase. This may enable transmission or reception through beamforming between the electronic device 201 and the outside.

The second cellular network 294 may be operated independently of the first cellular network 292 (e.g., standalone (SA)) or in connection to the first cellular network 292 (e.g., non-standalone (NSA)). For example, a 5G network may include only an access network (e.g., a 5G radio access network (RAN) or a next generation RAN (NG RAN)) and may not include a core network (e.g., a next generation core (NGC)). In this case, after accessing an access network of the 5G network, the electronic device 201 may access an external network (e.g., the Internet) under a control of a core network (e.g., an evolved packet core (EPC)) of a legacy network. Protocol information (e.g., LTE protocol information) for communication with a legacy network or protocol information (e.g., NR protocol information) for communication with the 5G network may be stored in a memory (e.g., the memory 130 of FIG. 1) to be accessed by the processor 210.

The electronic device according to one or more embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

One or more embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. A singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms such as “1st,” and “2nd,” or “first” and “second” may be used to simply distinguish a corresponding component from another, and do not limit the components in other aspect (e.g., importance or order). If a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., through a wire or wires), wirelessly, or via a third component.

As used in connection with one or more embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part of the single integral component, adapted to perform one or more functions. For example, according to an embodiment, the module may be implemented in a form of an application-specific integrated circuit (ASIC).

One or more embodiments as set forth herein may be implemented as software (e.g., the program 140) including one or more instructions that are stored in a storage medium (e.g., the internal memory 136 or the external memory 138) that is readable by a machine (e.g., the electronic device 101) For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore^{TM}), or between two user devices (e.g., smartphones) directly. If distributed online, at least part of the computer program product may be temporarily generated or at least temporarily stored in the machine-readable storage medium, such as memory of the manufacturer’s server, a server of the application store, or a relay server.

According to one or more embodiments, each component (e.g., a module or a program) of the above-described components may include a single entity or multiple entities, and some of the multiple entities may be separately disposed in different components. According to one or more embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

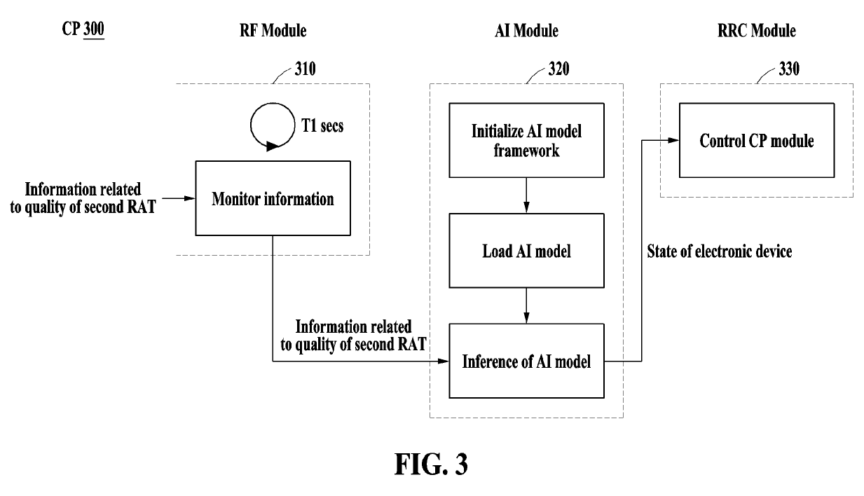

FIG. 3 is a block diagram illustrating an operation of an electronic device, according to an embodiment.

Referring to FIG. 3, a CP 300 (e.g., the processor 120 of FIG. 1 or the processor 210 of FIG. 2) may include an RF module 310, an artificial intelligence (AI) module 320, and a radio resource control (RRC) module 330 (or a radio resource management (RRM) module). FIG. 3 illustrates the above components of the CP 300, but in other embodiments, other general-purpose components may be included in the CP 300. In an embodiment, the CP 300 and the above described components of the CP 300 may be implemented in software, hardware, or their combinations.

According to an embodiment, the RF module 310 may receive information related to the quality of second radio-access technology (RAT). When a change to lower RAT occurs while an electronic device (e.g., the electronic device 101 of FIG. 1 or the electronic device 201 of FIG. 2) is connected to first RAT, the lower RAT may be second RAT. For example, when inter-radio access technology (IRAT) reselection, redirection, or handover occurs to the lower RAT while the electronic device is connected to the first RAT, the lower RAT may be the second RAT. For example, the first RAT may be 5G and the second RAT may be 4G or 3G.

According to an embodiment, when the second RAT is 4G, the information related to the quality of the second RAT may include a quality indicator of 4G. The quality indicator may include at least one of a first received signal strength indicator (RSSI), reference signal received power (RSRP), a signal-to-interference-plus-noise ratio (SINR), and a reference signal received quality (RSRQ). When the second RAT is 3G, the information related to the quality of the second RAT may include at least one of a second RSSI, energy-per-chip over the interference noise (Ec/Io), received signal code power (RSCP), and a signal-to-noise ratio (SNR).

According to an embodiment, the RF module 310 may monitor the information related to the quality of the second RAT every predetermined period “T1 secs” (e.g., 1 second). The monitored information related to the quality of the second RAT may be used for smooth communication with a network (e.g., the second network 199 of FIG. 1 or the second network 199 of FIG. 2) to which the electronic device is connected. In addition, the monitored information related to the quality of the second RAT may be transmitted to the AI module 320.

According to an embodiment, the AI module 320 may initialize an AI model framework when the electronic device is booted. When the AI model framework is initialized, the AI module 320 may load a trained AI model. The AI module 320 may periodically receive the information related to the quality of the second RAT from the RF module 310. The AI module 320 may input the information related to the quality of the second RAT to the AI model. The training of the AI model is described below.

According to an embodiment, the AI model may infer the state of the electronic device based on the information related to the quality of the second RAT. The state of the electronic device may include whether the electronic device enters a zone causing a change in the RAT and whether the electronic device leaves the zone causing a change in the RAT. The zone causing a change in the RAT may include a zone (e.g., an elevator, a basement, or the like) that degrades the signal quality of the current RAT (e.g., the first RAT) and causes IRAT reselection, redirection, or handover.

According to an embodiment, the RRC module 330 may control the CP based on the inference result of the AI model. For example, the RRC module 330 may perform a recovery algorithm to the first RAT based on the inference result of the AI model. For example, the RRC module 330 may block an operation of the recovery algorithm to the first RAT based on the inference result of the AI model.

Hereinafter, the operations of each module described above based on the electronic device are described in detail.

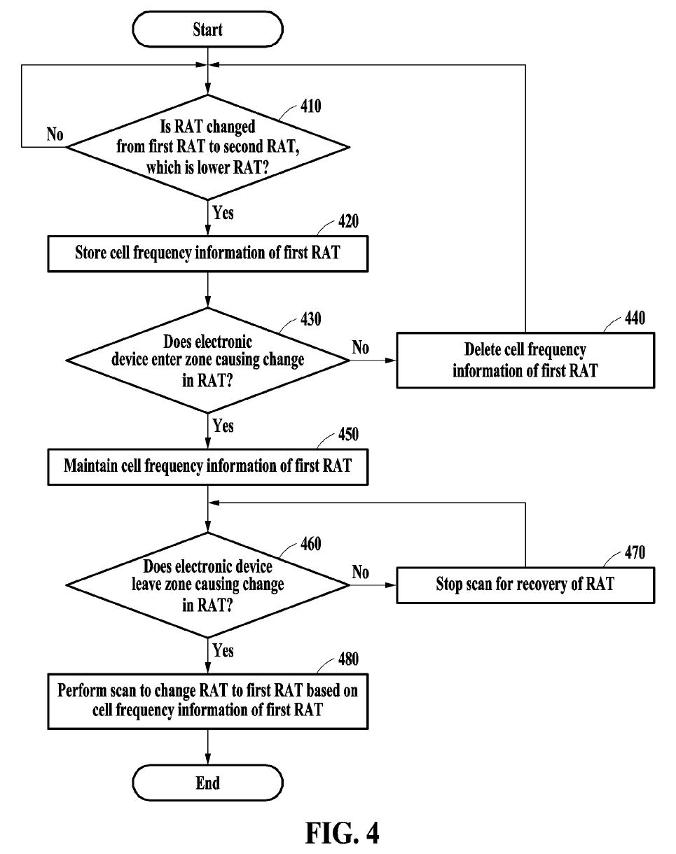

FIG. 4 is a flowchart illustrating an operation of an electronic device, according to an embodiment.

In the following embodiments, the operations may be performed sequentially but not necessarily. For example, the order of the operations may be changed and at least two of the operations may be performed in parallel. Additionally, some operations may be omitted in some embodiments.

Operations 410 to 480 may be performed by at least one component (e.g., the processor 120 of FIG. 1 or the processor 210 of FIG. 2) of an electronic device (e.g., the electronic device 101 of FIG. 1 or the electronic device 201 of FIG. 2). For example, instructions stored in a memory (e.g., the memory 130 of FIG. 1) may be executed by at least one processor individually or collectively, and the instructions may cause the electronic device to perform operations 410 to 480 below. The at least one processor may include at least one CP (e.g., the processor 210 of FIG. 2).

In operation 410, the electronic device may determine whether RAT is changed from first RAT to second RAT, which is lower RAT.

According to an embodiment, the electronic device may determine whether the RAT being used in a network to which the electronic device is connected is changed from the first RAT to the second RAT, which is the lower RAT. For example, when the first RAT is 5G, the second RAT may be determined to be 4G or 3G. For example, the second RAT may be determined to be 3G when the first RAT is 4G. The first RAT and the second RAT described above are merely examples and should not be construed as limiting or defining the scope of other embodiments.

According to an embodiment, the electronic device may perform operation 420 when the RAT is changed to the second RAT in operation 410. When the RAT is not changed to the second RAT in operation 410, the electronic device may perform operation 410 again. For example, the electronic device may periodically monitor whether the RAT is changed to the second RAT when the RAT is not changed to the second RAT in operation 410.

In operation 420, the electronic device may store cell frequency information of the first RAT. When the RAT is changed to the second RAT, the electronic device may store the cell frequency information of the first RAT for quick recovery to the first RAT later. The cell frequency information may include information related to a frequency band used by a cell that provides the first RAT.

In operation 430, the electronic device may determine whether the electronic device enters a zone causing a change in the RAT.

According to an embodiment, based on a trained AI model, the electronic device may determine whether the electronic device enters the zone causing a change in the RAT. The zone causing a change in the RAT may include a zone (e.g., in an elevator, a basement, a tunnel, or in a subway) that degrades the signal quality of the current RAT (e.g., the first RAT) and causes IRAT reselection, redirection, or handover.

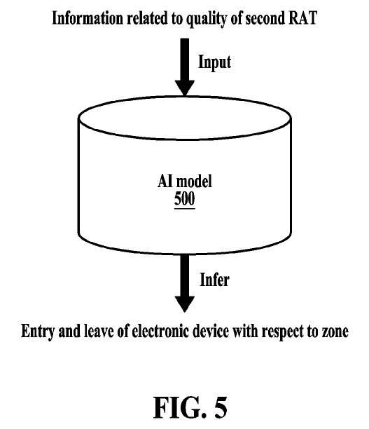

According to an embodiment, based on the AI model trained to determine whether the electronic device enters and/or leaves the zone causing a change in the RAT by using information related to the quality of the second RAT as an input, the electronic device may determine whether the electronic device enters the zone. The AI model may be executed in the AI module of FIG. 3. The AI model is described below with reference to FIGS. 5-8.

According to an embodiment, when it is determined, for example, by the CP 300 of FIG. 3, that the electronic device enters the zone causing a change in the RAT in operation 430, the electronic device may perform operation 450. When it is not determined, for example, by the CP 300 of FIG. 3, that the electronic device enters the zone causing a change in the RAT in operation 430, the electronic device may perform operation 440.

In operation 440, the electronic device may delete the cell frequency information of the first RAT.

According to an embodiment, when a change in the RAT to the second RAT occurs but it is determined that the electronic device does not enter the zone causing a change in the RAT, the change in the RAT may be temporary. The change in the RAT may be temporary, and the electronic device may not need to store the cell frequency information for recovery to the first RAT later. The electronic device may delete the cell frequency information of the first RAT. The electronic device may perform a change to higher RAT through a basic scan that is applied to the electronic device. For example, the electronic device may perform a change to the higher RAT based on a recovery algorithm (e.g., a basic scan) to the higher RAT based on the standard specifications applied to the electronic device.

In operation 450, the electronic device may maintain the cell frequency information of the first RAT.

According to an embodiment, when a change in the RAT to the second RAT occurs and it is determined that the electronic device enters the zone causing a change in the RAT, the electronic device may maintain the cell frequency information of the first RAT. The electronic device may maintain the cell frequency information stored for recovery to the first RAT.

In operation 460, the electronic device may determine whether the electronic device leaves the zone causing a change in the RAT.

According to an embodiment, based on the AI model trained to determine whether the electronic device enters and/or leaves the zone causing a change in the RAT by using the information related to the quality of the second RAT as an input, the electronic device may determine whether the electronic device leaves the zone.

According to an embodiment, in operation 460, when it is determined that the electronic device leaves the zone causing a change in the RAT, the electronic device may perform operation 480. When it is determined that the electronic device does not leave the zone causing a change in the RAT in operation 460, the electronic device may perform operation 470.

In operation 470, the electronic device may stop a scan for recovery of the RAT.

According to an embodiment, the scan for a change to the higher RAT (e.g., the first RAT) may be meaningless when the electronic device does not leave the zone causing a change in the RAT. When the electronic device is in the zone causing a change in the RAT, the signal of the first RAT may be weak, so even when the RAT is changed to the first RAT, the RAT may be changed to the second RAT again. The electronic device may prevent a meaningless scan by stopping the scan for recovery of the RAT. The electronic device may save power of the electronic device by stopping the scan for recovery of the RAT. According to an embodiment, when the electronic device stops the scan for recovery of the RAT in operation 470, the electronic device may periodically perform operation 460 of determining whether the electronic device leaves the zone causing a change in the RAT.

In operation 480, the electronic device may perform a scan to change the RAT to the first RAT based on the cell frequency information of the first RAT.

According to an embodiment, when it is determined that the electronic device leaves the zone causing a change in the RAT, the electronic device may perform the scan to change the RAT to the first RAT based on the cell frequency information of the first RAT. The electronic device may perform the scan to change the RAT to the first RAT based on the stored cell frequency information. The electronic device may perform the scan to change to the first RAT used before being changed to the second RAT based on the cell frequency information. The electronic device may preferentially scan the first RAT used before being changed to the second RAT based on the cell frequency information.

According to an embodiment, the electronic device may attempt to connect to the first RAT when the first RAT used before being changed to the second RAT is found through the scan. When the first RAT is found, the electronic device may hand-over the RAT to the first RAT.

According to an embodiment, the first RAT used before being changed to the second RAT may not be found through the scan. For example, when a cell is changed due to the movement of the electronic device, the first RAT may not be found through the scan. The electronic device may perform a basic scan to find the higher RAT than the second RAT. The basic scan may be a scan based on the recovery algorithm to the higher RAT that is applied to the electronic device based on the standard specifications without preferentially scanning the first RAT.

According to an embodiment, the determination of whether the electronic device enters or leaves the zone causing a change in the RAT may not be performed while the electronic device is performing a predetermined operation. For example, while a user is making a call using the electronic device, the determination of whether the electronic device enters or leaves the zone causing a change in the RAT may not be performed.

According to an embodiment, based on the AI model, the electronic device may improve the user’s network connection experience by identifying the leave from the zone causing a change in the RAT and performing recovery to the previously connected first RAT. The AI model may be used to recover the first RAT faster than the basic scan after leaving the zone causing a change in the RAT.

Hereinafter, the AI model is described.

FIG. 5 is a diagram illustrating an AI model according to an embodiment.

The AI model 500 may be trained to infer the state of an electronic device (e.g., the electronic device 101 of FIG. 1 or the electronic device 201 of FIG. 2) with respect to a zone (e.g., a zone where an electronic device causes a change in RAT) by using information related to the quality of second RAT as an input. The state of the electronic device with respect to the zone may include entry and/or leave of the electronic device with respect to the zone. When first RAT is 5G, second RAT may be 4G or 3G. When the first RAT is 4G, the second RAT may be 3G.

According to an embodiment, the information related to the quality may include at least one quality indicator indicating the quality of the currently connected RAT. The information related to the quality may include an indicator related to the electric field of the currently connected RAT. For example, when the currently connected RAT is 4G, the information related to the quality may include at least one of a first RSSI, RSRP, SINR, and RSRQ. For example, when the currently connected RAT is 3G, the information related to the quality may include at least one of a second RSSI, Ec/Io, RSCP, and SNR.

According to an embodiment, the entry and/or leave of the electronic device with respect to the zone may include entry, while entering, entry completed, leave, while leaving, leave completed, an enterable state, and/or a leavable state with respect to the zone causing a change to the second RAT.

For example, the zone causing a change to the second RAT is in the elevator. The entry and/or leave of the electronic device may include entry, while entering, or entry completed into the elevator. The entry and/or leave of the electronic device may include getting off the elevator, while getting off the elevator, or getting off completed. The entry and/or leave of the electronic device may include an enterable state to the elevator (e.g., the electronic device is outside the elevator and the elevator door is open) and a leavable state (e.g., the electronic device is inside the elevator and the elevator door is open). However, the entry and/or leave of the electronic device described above is merely an example and should not be construed as limiting or defining the scope of other embodiments.

According to an embodiment, the AI model 500 may be one of a DNN, a CNN, an RNN, an RBM, a DBN, an RDNN, a deep Q-network, or a combination of two or more of the above examples. The AI model 500 may be trained based on training data in which ground truth of the entry and/or leave of the electronic device with respect to the zone is labeled to the information related to the quality of the second RAT. The AI model 500 in which training is completed may be mounted on the electronic device. For example, the AI model 500 in which training is completed may be mounted on at least one CP (e.g., the processor 210 of FIG. 2). The AI model 500 in which training is completed may be executed by the at least one CP. The AI model 500 in which training is completed may predict the entry and/or leave of the electronic device with respect to the zone based on the information related to the quality of the second RAT, which is periodically acquired from the at least one CP.

According to an embodiment, the AI model 500 may predict the entry and/or leave of the electronic device with respect to the zone using only the information related to the quality of the second RAT. For example, the AI model 500 may predict the entry and/or leave of the electronic device without sensor data collected by a sensor module (e.g., the sensor module 176 of FIG. 1).

In an embodiment, the AI model 500 may be mounted on the at least one CP and use only the information related to the quality of the second RAT, an AP and a sensor module may not be involved in performing the embodiments of the present disclosure. For example, only a CP may be used to perform the embodiments of the present disclosure. As the sensor module is not involved, additional power consumption for receiving sensor data may be reduced. As the sensor module is not involved, the embodiments of the present disclosure may be performed even in an electronic device (e.g., a low-cost terminal and ultra-small Internet of Things (IoT)) that does not include the sensor module. As the AP is not involved, communication with the AP is unnecessary, and thus, latency may not occur.

In an embodiment, the AI model 500 may be mounted on the CP and the AP and be connected with the sensor in performing the embodiments of the present disclosure. For example, the sensor data may be additionally used to predict the entry and/or leave of the electronic device with respect to the zone.

Hereinafter, the training data and the information related to the quality of the second RAT are described.

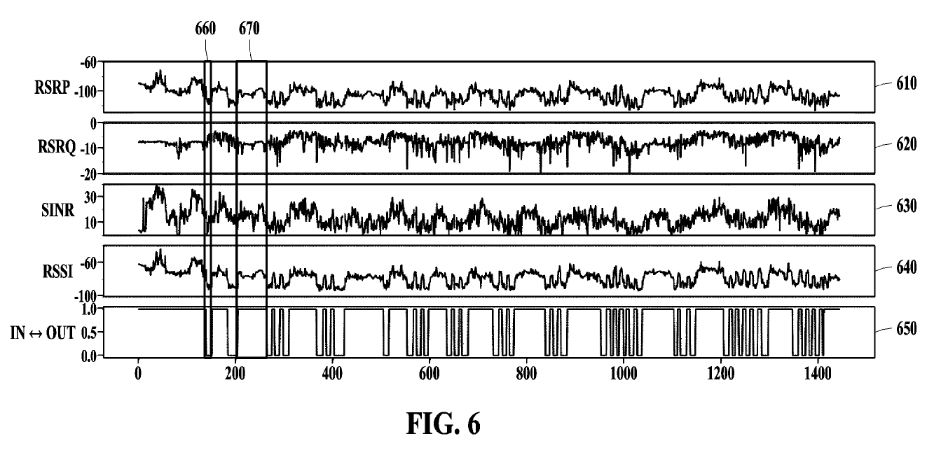

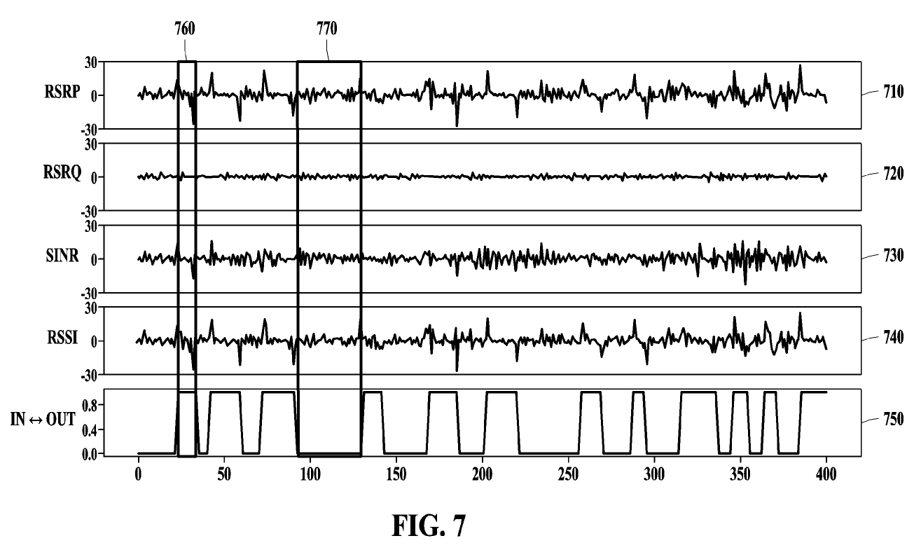

FIGS. 6 and 7 are diagrams illustrating training data that is input to an AI model, according to an embodiment.

FIG. 6 illustrates information related to the quality of second RAT and ground truth 650 of the entry and/or leave of an electronic device (e.g., the electronic device 101 of FIG. 1 or the electronic device 201 of FIG. 2) with respect to a zone, which is labeled to the information.

Hereinafter, as a non-limiting example, the second RAT is 4G. For example, FIG. 6 illustrates RSRP 610, an RSRQ 620, an SINR 630, and an RSSI 640, which are quality indicators of 4G. The RSRP 610, the RSRQ 620, the SINR 630, and the RSSI 640 may represent instantaneous values. In an embodiment, the following description may be equally applied even when the second RAT is 3G. For example, the following description may be equally applied even when the second RAT is 3G and the information related to the quality of the second RAT includes at least one of an RSSI, Ec/Io, RSCP, and SNR.

According to an embodiment, the RSRP 610 may indicate the strength of a reference signal transmitted from a base station. The RSRQ 620 may indicate the quality of a reference signal transmitted from the base station. The SINR 630 may indicate the degree to which a particular signal is dominant over other interference signals and noise. The RSSI 640 may indicate the strength of all signals received from a particular base station.

According to an embodiment, the RSRP 610, the RSRQ 620, the SINR 630, and the RSSI 640 may be sampled every predetermined period. For example, the RSRP 610, the RSRQ 620, the SINR 630, and the RSSI 640 may be acquired every predetermined period.

According to an embodiment, the ground truth 650 may be ground-truth data indicating the entry and/or leave of the electronic device with respect to the zone causing a change in RAT. For ease of description, in FIG. 6, the ground truth 650 may include only entry (e.g., IN) and leave (e.g., OUT) with respect to the zone. However, this is merely an example and should not be construed as limiting or defining the scope of other embodiments. For example, depending on the training purpose of an AI model, the ground truth 650 may include entry, while entering, entry completed, leave, while leaving, leave completed, an enterable state, a leavable state, or a combination of two or more of the above states with respect to the zone causing a change to the second RAT.

According to an embodiment, the training data may be generated as the ground truth 650 is labeled to the information related to the quality of the second RAT. The information related to the quality of the second RAT may include at least one of the RSRP 610, the RSRQ 620, the SINR 630, and the RSSI 640.

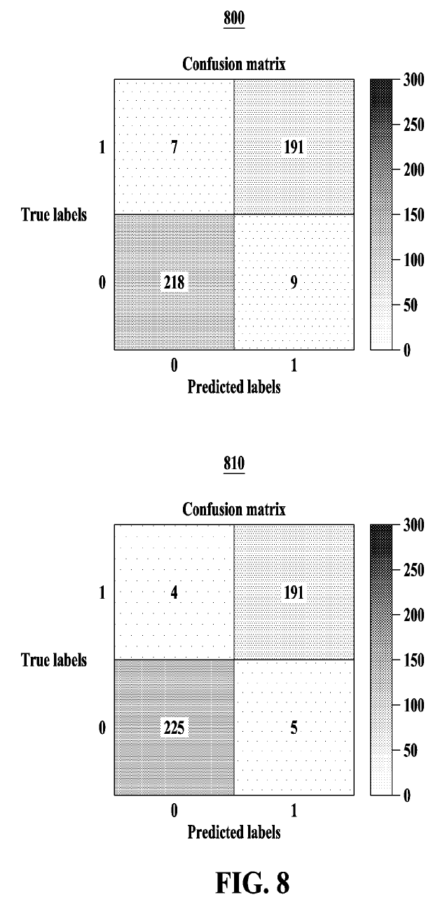

According to an embodiment, a plurality of AI models (e.g., the AI model 500 of FIG. 5) may be trained based on a plurality of training data sets. The plurality of training data sets may include pieces of information related to the quality of the second RAT, which are different from each other, and the ground truth 650 labeled to the pieces of information. Among the plurality of AI models trained based on each of the plurality of training data sets, an AI model having the best performance may be mounted on the electronic device. The performance of the plurality of training data sets is described below with reference to FIG. 8.

For example, each of the plurality of training data sets may include one or more quality indicators, which are different from each other. For example, a first training data set may include the RSRP 610 and the RSRQ 620 as the information related to the quality of the second RAT. A second training data set may include the RSRP 610 and the SINR 630 as the information related to the quality of the second RAT. A third training data set may include the RSRP 610, the RSRQ 620, the SINR 630, and the RSSI 640 as the information related to the quality of the second RAT.

According to an embodiment, the number of time series samples that is input to the AI model at a time may be the same or different for each of the plurality of training data sets. For example, when training the AI model based on the first training data set, five time series samples may be input to the AI model at a time. When training the AI model based on the second training data set, ten time series samples may be input to the AI model at a time. The optimal number of time series samples to be input to the AI model at a time may be determined by making the number of time series samples that is input to the AI model at a time the same or different for each of the plurality of training data sets.

According to an embodiment, the AI model may train a pattern indicated by at least one quality indicator included in the information related to the quality of the second RAT of the training data. The AI model may train the pattern (e.g., a first pattern) based on an instantaneous value of the at least one quality indicator included in the information related to the quality of the second RAT. When the information related to the quality of the second RAT is input, the AI model may train the pattern and infer whether the electronic device enters or leaves the zone causing a change in the RAT.

For example, a block 660 may represent the RSRP 610, the RSRQ 620, the SINR 630, the RSSI 640, and the ground truth 650 when the electronic device enters the zone (e.g., IN) causing a change in the RAT. A block 670 may represent the RSRP 610, the RSRQ 620, the SINR 630, the RSSI 640, and the ground truth 650 when the electronic device leaves (e.g., OUT) the zone causing a change in the RAT. Referring to the block 660, when the electronic device enters the zone, the size of the instantaneous value of the RSRP 610, the RSRQ 620, the SINR 630, and the RSSI 640 may be relatively smaller than that of the block 670. Referring to the block 660, when the electronic device enters the zone, the size of the change rate of the RSRP 610, the RSRQ 620, the SINR 630, and the RSSI 640 may be relatively larger than that of the block 670. The AI model may train the pattern described above and infer whether the electronic device enters or leaves the zone causing a change in the RAT.

Hereinafter, a method of using a differential value is described.

FIG. 7 illustrates information related to the quality of second RAT and ground truth 750 of the entry and/or leave of an electronic device (e.g., the electronic device 101 of FIG. 1 or the electronic device 201 of FIG. 2) with respect to a zone, which is labeled to the information.

Hereinafter, as a non-limiting example, the second RAT is 4G. For example, FIG. 7 illustrates RSRP 710 (e.g., the RSRP 610 of FIG. 6), an RSRQ 720 (e.g., the RSRQ 620 of FIG. 6), an SINR 730 (e.g., the SINR 630 of FIG. 6), and an RSSI 740 (e.g., the RSSI 640 of FIG. 6), which are quality indicators of 4G. The RSRP 710, the RSRQ 720, the SINR 730, and the RSSI 740 may represent differential values. For example, the RSRP 710, the RSRQ 720, the SINR 730, and the RSSI 740 may represent the differential values between two consecutive time series samples.

In an embodiment, the following description may be equally applied even when the second RAT is 3G.

According to an embodiment, the RSRP 710, the RSRQ 720, the SINR 730, and the RSSI 740 may be sampled every predetermined period. For example, the RSRP 710, the RSRQ 720, the SINR 730, and the RSSI 740 may be acquired every predetermined period.

According to an embodiment, the ground truth 750 may be ground-truth data indicating the entry and/or leave of the electronic device with respect to the zone causing a change in the RAT. For ease of description, in FIG. 7, the ground truth 750 may include only entry (e.g., IN) and leave (e.g., OUT) with respect to the zone. However, this is merely an example and should not be construed as limiting or defining the scope of other embodiments.

According to an embodiment, the training data may be generated as the ground truth 750 is labeled to the information related to the quality of the second RAT. The information related to the quality of the second RAT may include at least one of the RSRP 710, the RSRQ 720, the SINR 730, and the RSSI 740.

According to an embodiment, a plurality of AI models (e.g., the AI model 500 of FIG. 5) may be trained based on a plurality of training data sets. The plurality of training data sets may include pieces of information related to the quality of the second RAT, which are different from each other, and the ground truth 750 labeled to the pieces of information. Among the plurality of AI models trained based on each of the plurality of training data sets, an AI model having the best performance may be mounted on the electronic device. The performance of the plurality of training data sets is described below with reference to FIG. 8.

For example, each of the plurality of training data sets may include one or more quality indicators, which are different from each other. For example, a first training data set may include the RSRP 710 and the RSRQ 720 as the information related to the quality of the second RAT. A second training data set may include the RSRP 710 and the SINR 730 as the information related to the quality of the second RAT. A third training data set may include the RSRP 710, the RSRQ 720, the SINR 730, and the RSSI 740 as the information related to the quality of the second RAT.

According to an embodiment, the number of time series samples that is input to the AI model at a time may be the same or different for each of the plurality of training data sets. For example, when training the AI model based on the first training data set, five time series samples may be input to the AI model at a time. When training the AI model based on the second training data set, ten time series samples may be input to the AI model at a time. The optimal number of time series samples to be input to the AI model at a time may be determined by making the number of time series samples that is input to the AI model at a time the same or different for each of the plurality of training data sets.

According to an embodiment, the AI model may train a pattern indicated by at least one quality indicator included in the information related to the quality of the second RAT of the training data. The AI model may train the pattern (e.g., a second pattern) based on a differential value of the at least one quality indicator included in the information related to the quality of the second RAT. When the information related to the quality of the second RAT is input, the AI model may train the pattern and infer whether the electronic device enters or leaves the zone causing a change in the RAT.

For example, a block 760 may represent the RSRP 710, the RSRQ 720, the SINR 730, the RSSI 740, and the ground truth 750 when the electronic device leaves (e.g., OUT) the zone causing a change in the RAT. A block 770 may represent the RSRP 710, the RSRQ 720, the SINR 730, the RSSI 740, and the ground truth 750 when the electronic device enters the zone (e.g., IN) causing a change in the RAT. Referring to the block 760, when the electronic device leaves the zone, a differential value may rapidly increase immediately after leaving, and thus, a positive peak may occur. Referring to the block 760, a differential value may rapidly decrease immediately before the electronic device enters the zone, and thus, a negative peak may occur.

The AI model may train the pattern described above and infer whether the electronic device enters or leaves the zone causing a change in the RAT.

The training of the AI model based on the instantaneous and differential values of the RSRP, the RSRQ, the SINR, and the RSSI described with reference to FIGS. 6 and 7 is merely an example, and the embodiments are not limited thereto. In an embodiment, the differential, integral, mean, and variance values of the RSRP, the RSRQ, the SINR, and the RSSI may be used for training the AI model.

Hereinafter, a method of determining a target AI model to be mounted on the electronic device among a plurality of trained AI models is described.

FIG. 8 is a diagram illustrating the performance of an AI model, according to an embodiment.

FIG. 8 illustrates a confusion matrix representing the training performance of a plurality of AI models (e.g., the AI model 500 of FIG. 5).

A confusion matrix 800 may represent the training performance of an AI model trained by using, as information related to the quality of second RAT, all of RSRP, an RSRQ, an SINR, and an RSSI as inputs. A confusion matrix 810 may represent the training performance of an AI model trained by using, as the information related to the quality of the second RAT, only RSRP and an RSSI as inputs.

According to an embodiment, “0” in the predicted labels of a confusion matrix may indicate that the AI model predicts that an electronic device (e.g., the electronic device 101 of FIG. 1 or the electronic device 201 of FIG. 2) is inside (e.g., entry) a zone causing a change in RAT. “1” in the predicted labels of a confusion matrix may indicate that the AI model predicts that the electronic device is outside (e.g., leave) the zone causing a change in the RAT. “0” in the true labels of a confusion matrix may indicate that the electronic device is actually inside (e.g., entry) the zone causing a change in the RAT. “1” in the predicted labels of a confusion matrix may indicate that the electronic device is actually outside (e.g., leave) the zone causing a change in the RAT.

According to an embodiment, in the confusion matrix 800, when the electronic device is actually outside the zone, the number of times the AI model determines that the electronic device is outside the zone may be 218. In the confusion matrix 800, when the electronic device is actually inside the zone, the number of times the AI model determines that the electronic device is inside the zone may be 191. The total number of times the confusion matrix 800 incorrectly determines the actual location of the electronic device may be 16. The correct answer rate of the confusion matrix 800 may be about 92.23% (e.g., 409/425).

According to an embodiment, in the confusion matrix 810, when the electronic device is actually outside the zone, the number of times the AI model determines that the electronic device is outside the zone may be 225. In the confusion matrix 810, when the electronic device is actually inside the zone, the number of times the AI model determines that the electronic device is inside the zone may be 191. The total number of times the confusion matrix 810 incorrectly determines the actual location of the electronic device may be 9. The correct answer rate of the confusion matrix 800 may be about 97.88% (e.g., 416/425).

According to an embodiment, an AI model corresponding to a confusion matrix having the highest correct answer rate may be determined to be a target AI model to be mounted on the electronic device. For example, the AI model corresponding to the confusion matrix 810 may be determined to be the target AI model. For example, the AI model trained by using, as the information related to the quality of the second RAT, only the RSRP and the RSSI as inputs may be determined to be the target AI model.

However, the method of determining the target AI model to be mounted on the electronic device based on the confusion matrix described above is merely an example, and the embodiments are not limited thereto. For example, the target AI model may be determined based on a method of determining the performance of various AI models other than the confusion matrix.

Hereinafter, a method of further using sensor data to determine the location of the electronic device is described.

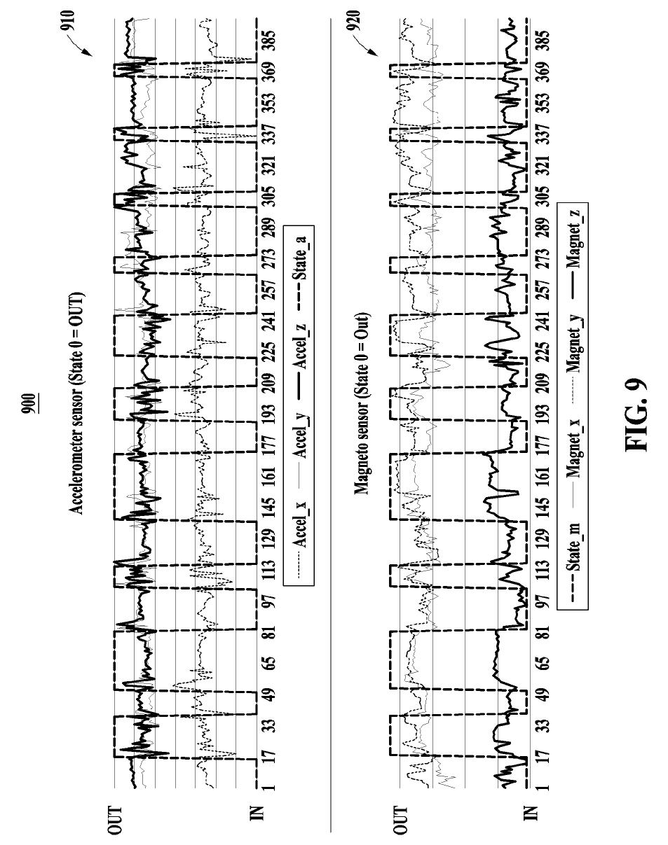

FIG. 9 is a diagram illustrating training data based on sensor data, according to an embodiment.

FIG. 9 illustrates training data 900 based on the sensor data. The sensor data may include sensor data of an accelerometer sensor and a magneto sensor. In an embodiment, the following description may be applied in addition to the sensor data collected from the acceleration sensor and the magneto sensor. For example, the following description may equally be applied to sensor data collected from a barometer sensor.

According to an embodiment, a training data set to train an AI model (e.g., the AI model 500 of FIG. 5) may further include training data based on the sensor data. For example, the training data set may include at least one of training data 910 based on the sensor data of the accelerometer sensor and training data 920 based on the sensor data of the magneto sensor.

According to an embodiment, the sensor data of the accelerometer sensor and the sensor data of the magneto sensor may include values of an x-axis, a y-axis, and a z-axis to measure force acting in a three-dimensional (3D) space. The training data 910 based on the sensor data of the accelerometer sensor may include the values of the x-axis, the y-axis, and the z-axis, and the state of an electronic device (e.g., the electronic device 101 of FIG. 1 or the electronic device 201 of FIG. 2), which is ground truth (e.g., the ground truth 650 of FIG. 6 or the ground truth 750 of FIG. 7) labeled to the values. The training data 920 based on the sensor data of the magneto sensor may include the values of the x-axis, the y-axis, and the z-axis, and the state of the electronic device, which is ground truth labeled to the values. The state of the electronic device may include whether the electronic device enters a zone causing a change in RAT and whether the electronic device leaves the zone causing a change in the RAT.

According to an embodiment, the AI model may be trained to infer the state of the electronic device by using the training data 900 based on the sensor data and the training data based on information related to the quality of second RAT as inputs. The trained AI model may receive the sensor data from at least one sensor. The trained AI model may determine whether the electronic device enters or leaves the zone causing a change in the RAT based on the sensor data and the information related to the quality of the second RAT.

According to an embodiment, the sensor data used for the training data 900 may be an instantaneous value or a differential value. In an embodiment, the differential, integral, mean, and variance values of the sensor data may be used.

According to an embodiment, the training data set may include both the training data 900 based on the sensor data and the training data based on the information related to the quality of the second RAT. The training data 900 based on the sensor data and the training data based on the information related to the quality of the second RAT may include different feature values. For example, the training data 900 based on the sensor data may be an instantaneous value, and the training data based on the information related to the quality of the second RAT may be a differential value.

Hereinafter, a representative embodiment of quickly recovering first RAT by determining whether the electronic device enters the zone causing a change in the RAT using the AI model described in the present disclosure is described.

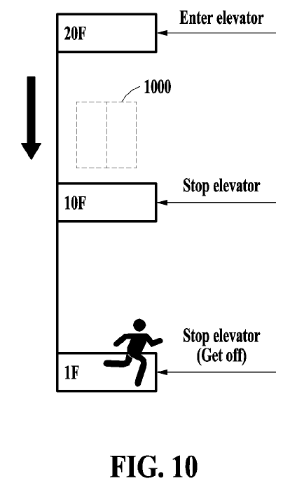

FIG. 10 is an example of a diagram illustrating an operation of an electronic device, according to an embodiment.

In FIG. 10, as an example, a user of an electronic device (e.g., the electronic device 101 of FIG. 1 or the electronic device 201 of FIG. 2) boards an elevator 1000 on the 20th floor of a building and moves to the 1st floor but stops on the 10th floor in the middle. In FIG. 10, a zone causing a change in RAT may be inside the elevator 1000.

In an example, while the user is waiting for the elevator 1000 on the 20th floor, the RAT being used by the electronic device may be changed from 5G to 4G, which is lower RAT. When the RAT is changed to 4G, the electronic device may store, in a memory (e.g., the memory 130 of FIG. 1), cell frequency information of 5G being used.

According to an embodiment, the electronic device may determine whether the electronic device enters inside the elevator 1000 based on an AI model (e.g., the AI model 500 of FIG. 5) trained to determine whether the electronic device enters and/or leaves the zone causing a change in the RAT. The electronic device may delete the cell frequency information of 5G from the memory when it is determined that the electronic device does not enter the elevator 1000. For example, while the user is waiting for the elevator 1000 on the 20th floor, a temporary error may cause the RAT to change from 5G to 4G, and the electronic device may delete the stored cell frequency information of 5G from the memory. The electronic device may recover 5G again through a basic scan.

According to an embodiment, the user may board the elevator 1000 when the elevator 1000 arrives on the 20th floor. As the user boards the elevator 1000, the 5G signal may weaken and the RAT may change to 4G. The electronic device may store the cell frequency information of 5G in the memory. The electronic device may determine that the electronic device enters the elevator 1000 based on the AI model. The electronic device may maintain the cell frequency information of 5G without deleting the cell frequency information of 5G when it is determined that the electronic device enters the elevator 1000.

According to an embodiment, it may be periodically determined whether the electronic device leaves the elevator 1000 based on the AI model. When it is determined that the electronic device does not leave the elevator 1000 based on the AI model, the electronic device may stop a scan for recovery of the 5G RAT.

According to an embodiment, when it is determined that the electronic device is in a state capable of leaving the zone based on the trained AI model even when the electronic device does not leave the zone causing a change in the RAT, the electronic device may perform a scan for changing the RAT to first RAT.

For example, the elevator 1000 may stop on the 10th floor to pick up another passenger, and the elevator door may open. The AI model may be trained to determine that the door opening of the elevator 1000 is also leaving the elevator 1000. As the AI model is trained to determine that the door opening of the elevator 1000 is also leaving the elevator 1000, the electronic device may attempt to change to 5G before leaving the elevator 1000 completely (e.g., the moment the door is open), thereby recovering 5G more quickly.

In an example, the user may get off the 1st floor. When the AI model is trained to determine that the door opening of the elevator 1000 is also leaving the elevator 1000, the electronic device may attempt to change to 5G from the time the door of the elevator 1000 is opened on the 1st floor. The user may get off the elevator 1000 and use 5G.

According to an embodiment, the AI model may be trained not to determine that the door opening of the elevator 1000 is leaving the elevator 1000. As the AI model is trained to determine that only when the electronic device leaves the elevator 1000 is the “leave,” the electronic device may attempt to change to 5G from the time the electronic device leaves the elevator 1000, not from the time the door is opened.

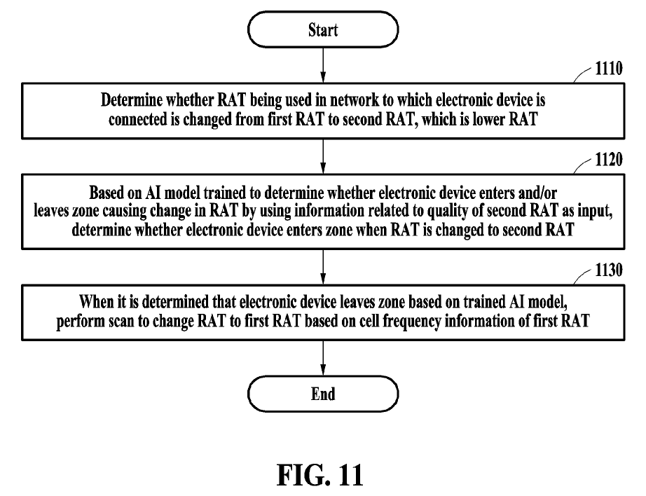

FIG. 11 is a flowchart illustrating an operation of an electronic device, according to an embodiment.

In the following embodiments, the operations may be performed sequentially but not necessarily. For example, the order of the operations may be changed and at least two of the operations may be performed in parallel. Additionally, some operations may be omitted in some embodiments.

Operations 1110 to 1130 may be performed by at least one component (e.g., the processor 120 of FIG. 1, the processor 210 of FIG. 2, or the CP 300 of FIG. 3) of an electronic device (e.g., the electronic device 101 of FIG. 1 or the electronic device 201 of FIG. 2). For example, instructions stored in a memory (e.g., the memory 130 of FIG. 1) may be executed by at least one processor individually or collectively, and the instructions may cause the electronic device to perform operations 1110 to 1130 below. The at least one processor may include at least one CP (e.g., the processor 210 of FIG. 2).

In operation 1110, the electronic device may determine whether RAT being used in a network to which the electronic device is connected is changed from first RAT to second RAT, which is lower than the first RAT.

In operation 1120, based on determining that the RAT is changed to the second RAT, the electronic device may determine whether the electronic device enters a zone, using an artificial intelligence (AI) model(e.g., the AI model 500 of FIG. 5).

The AI model is trained to determine whether the electronic device enters or leaves the zone causing a change of the RAT by using information related to a quality of the second RAT as an input to the AI model.

In operation 1130, based on determining that the electronic device leaves the zone, the electronic device may perform a scan to change the RAT to the first RAT based on cell frequency information of the first RAT.

According to an embodiment, the instructions, when executed by the at least one processor (e.g., the processor 120 of FIG. 1, the processor 210 of FIG. 2 or the CP 300 of FIG. 3) individually or collectively may cause the electronic device (e.g., the electronic device 101 of FIG. 1 or the electronic device 201 of FIG. 2) to stop the scan until the electronic device leaves the zone based on determining that the electronic device enters the zone.

According to an embodiment, the at least one processor may include at least one CP that executes the AI model.

According to an embodiment, the instructions, when executed by the at least one processor individually or collectively, may cause the electronic device to store the cell frequency information of the first RAT based on the RAT being changed from the first RAT to the second RAT. The instructions, when executed by the at least one processor individually or collectively, may cause the electronic device to delete or maintain the cell frequency information based on whether the electronic device enters the zone, which is determined using the AI model.

According to an embodiment, the AI model may determine whether the electronic device enters the zone based on a pattern indicated by at least one quality indicator in the information. The AI model may determine whether the electronic device leaves the zone based on a pattern indicated by at least one quality indicator in the information.

According to an embodiment, the pattern may include a first pattern based on an instantaneous value of the at least one quality indicator. The pattern may include a second pattern based on a differential value of the at least one quality indicator.

According to an embodiment, the AI model may receive sensor data from at least one sensor. The AI model may determine whether the electronic device enters the zone based on the information and the sensor data. The AI model may determine whether the electronic device leaves the zone based on the information and the sensor data.

According to an embodiment, the instructions, when executed by the at least one processor individually or collectively, may cause the electronic device to perform the scan to change the RAT to the first RAT, based on determining that the electronic device is in a state capable of leaving the zone based on the AI model in a case that the electronic device stays in the zone.

According to an embodiment, the instructions, when executed by the at least one processor individually or collectively, may cause the electronic device to perform a basic scan that is applied to the electronic device to identify a RAT higher than the second RAT, based on the first RAT corresponding to the cell frequency information not being identified through the scan.

According to an embodiment, wherein the second RAT is 4G, and the information may include at least one of a first RSSI (e.g., the RSSI 640 of FIG. 6 or the RSSI 740 of FIG. 7), RSRP (e.g., the RSRP 610 of FIG. 6 or the RSRP 710 of FIG. 7), an SINR (e.g., the SINR 630 of FIG. 6 or the SINR 730 of FIG. 7), and an RSRQ (e.g., the RSRQ 620 of FIG. 6 or the RSRQ 720 of FIG. 7).

According to an embodiment, wherein the second RAT is 3G, and the information may include at least one of a second RSSI, Ec/Io, RSCP, and an SNR.

According to an embodiment, an electronic device may include at least one processor including processing circuitry. The electronic device may include memory (e.g., the memory 130 of FIG. 1) storing instructions. The instructions, when executed by the at least one processor individually or collectively, may cause the electronic device to determine whether a RAT being used in a network to which the electronic device is connected is changed from a first RAT to a second RAT, which is lower than the first RAT. The instructions, when executed by the at least one processor individually or collectively, may cause the electronic device to, based on determining that the RAT is changed to the second RAT, determine, based on an artificial intelligence (AI) model, whether the electronic device enters a zone. The AI model is trained to determine whether the electronic device enters or leaves the zone causing a change of the RAT by using information related to a quality of the second RAT as an input to the AI model. The instructions, when executed by the at least one processor individually or collectively, may cause the electronic device to, based on determining that the electronic device enters the zone, stop a scan for the electronic device to change from the RAT to the first RAT.

According to an embodiment, an operating method of an electronic device may include determining whether a RAT being used in a network to which the electronic device is connected is changed from a first RAT to a second RAT, which is lower than the first RAT. The operating method of the electronic device may include, based on determining that the RAT is changed to the second RAT, determining, using an artificial intelligence (AI) model, whether the electronic device enters a zone when the RAT is changed to the second RAT. The AI model is trained to determine whether the electronic device enters or leaves the zone causing a change of the RAT by using information related to a quality of the second RAT as an input to the AI model. The operating method of the electronic device may include, based on determining that the electronic device leaves the zone, performing a scan to change the RAT to the first RAT based on cell frequency information of the first RAT.

According to an embodiment, the operating method of the electronic device may further include causing the electronic device to, based on determining that the electronic device enters the zone, stopping the scan until the electronic device leaves the zone.

According to an embodiment, the AI model may be executed through at least one CP of the electronic device.

According to an embodiment, the operating method of the electronic device may further include, based on the RAT being changed from the first RAT to the second RAT, storing the cell frequency information of the first RAT. The operating method of the electronic device may further include deleting or maintaining the cell frequency information based on whether the electronic device enters the zone, which is determined based on the AI model.

According to an embodiment, the AI model may determine whether the electronic device enters the zone based on a pattern indicated by at least one quality indicator included in the information. The AI model may determine whether the electronic device leaves the zone based on the pattern indicated by the at least one quality indicator included in the information.

According to an embodiment, the pattern may include a first pattern based on an instantaneous value of the at least one quality indicator. The pattern may include a second pattern based on a differential value of the at least one quality indicator.

According to an embodiment, the AI model may receive sensor data from at least one sensor. The AI model may determine whether the electronic device enters the zone based on the information and the sensor data. The AI model may determine whether the electronic device leaves the zone based on the information and the sensor data.

According to an aspect of the disclosure, a non-transitory computer-readable storage medium storing one or more computer programs. The one or more computer programs comprising instructions. The instructions, when executed by at least one processor individually or collectively, cause an electronic device to: determine whether a radio-access technology (RAT) being used in a network to which the electronic device is connected is changed from a first RAT to a second RAT which is lower than the first RAT. The instructions, when executed by the at least one processor individually or collectively, cause the electronic device to: based on determining that the RAT is changed to the second RAT, determine, using an artificial intelligence (AI) model, whether the electronic device enters a zone. The AI model is trained to determine whether the electronic device enters or leaves the zone causing a change of the RAT by using information related to a quality of the second RAT as an input to the AI model. The instructions, when executed by the at least one processor individually or collectively, cause the electronic device to: based on determining that the electronic device leaves the zone, perform a scan to change the RAT to the first RAT based on cell frequency information of the first RAT.

The embodiments of the present disclosure disclosed in the specification and the drawings are merely presented to easily describe technical contents of one or more embodiments of the present disclosure and help the understanding of them and are not intended to limit the one or more embodiments. Therefore, all changes or modifications derived from the technical idea of the one or more embodiments of the present disclosure as well as the one or more embodiments disclosed herein should be construed to fall within the one or more embodiments.

What is claimed is:

1. An electronic device comprising:
at least one processor including processing circuitry; and
memory storing instructions,
wherein the instructions, when executed by the at least one processor individually or collectively, cause the electronic device to:
determine whether a radio-access technology (RAT) being used in a network to which the electronic device is connected is changed from a first RAT to a second RAT which is lower than the first RAT,
based on determining that the RAT is changed to the second RAT, determine, using an artificial intelligence (AI) model, whether the electronic device enters a zone, wherein the AI model is trained to determine whether the electronic device enters or leaves the zone causing a change of the RAT by using information related to a quality of the second RAT as an input to the AI model, and
based on determining that the electronic device leaves the zone, perform a scan to change the RAT to the first RAT based on cell frequency information of the first RAT.

2. The electronic device of claim 1, wherein the instructions, when executed by the at least one processor individually or collectively, further cause the electronic device to, based on determining that the electronic device enters the zone, stop the scan until the electronic device leaves the zone.

3. The electronic device of claim 1, wherein the at least one processor comprises at least one communication processor (CP) configured to execute the AI model.

4. The electronic device of claim 1, wherein the instructions, when executed by the at least one processor individually or collectively, further cause the electronic device to:
based on the RAT being changed from the first RAT to the second RAT, store the cell frequency information of the first RAT , and
delete or maintain the cell frequency information based on whether the electronic device enters the zone, which is determined using the AI model.

5. The electronic device of claim 1, wherein the AI model is configured to determine whether the electronic device enters the zone and whether the electronic device leaves the zone, based on a pattern indicated by at least one quality indicator in the information.

6. The electronic device of claim 5, wherein the pattern comprises a first pattern based on an instantaneous value of the at least one quality indicator or a second pattern based on a differential value of the at least one quality indicator.

7. The electronic device of claim 1, wherein the AI model is configured to:
receive sensor data from at least one sensor, and
determine whether the electronic device enters the zone and whether the electronic device leaves the zone, based on the information and the sensor data.

8. The electronic device of claim 1, wherein the instructions, when executed by the at least one processor individually or collectively, further cause the electronic device to perform the scan to change the RAT to the first RAT, based on determining that the electronic device is in a state capable of leaving the zone based on the AI model in a case that the electronic device stays in the zone.

9. The electronic device of claim 1, wherein the instructions, when executed by the at least one processor individually or collectively, further cause the electronic device to, based on the first RAT corresponding to the cell frequency information not being identified through the scan, perform a basic scan that is applied to the electronic device to identify a RAT higher than the second RAT.

10. The electronic device of claim 1, wherein the second RAT is fourth generation (4G) and the information comprises at least one of a first received signal strength indicator (RSSI), reference signal received power (RSRP), a signal-to-interference-plus-noise ratio (SINR), and a reference signal received quality (RSRQ).

11. The electronic device of claim 1, wherein the second RAT is third generation (3G) and the information comprises at least one of a second RSSI, energy-per-chip over the interference noise (Ec/Io), received signal code power (RSCP), and a signal-to-noise ratio (SNR).

12. An electronic device comprising:
at least one processor including processing circuitry; and
memory storing instructions,
wherein the instructions, when executed by the at least one processor individually or collectively, cause the electronic device to:
determine whether a radio-access technology (RAT) being used in a network to which the electronic device is connected is changed from a first RAT to a second RAT which is lower than the first RAT,
based on determining that the RAT is changed to the second RAT, determine, based on an artificial intelligence (AI) model, whether the electronic device enters a zone, wherein the AI model is trained to determine whether the electronic device enters or leaves the zone causing a change of the RAT by using information related to a quality of the second RAT as an input to the AI model, and
based on determining that the electronic device enters the zone, stop a scan for the electronic device to change from the RAT to the first RAT.

13. An operating method of an electronic device, the operating method comprising:
determining whether a radio-access technology (RAT) being used in a network to which the electronic device is connected is changed from a first RAT to a second RAT which is lower than the first RAT;
based on determining that the RAT is changed to the second RAT, determining, using an artificial intelligence (AI) model, whether the electronic device (101, 201) enters a zone when the RAT is changed to the second RAT, wherein the AI model is trained to determine whether the electronic device enters or leaves the zone causing a change of the RAT by using information related to a quality of the second RAT as an input to the AI model; and
based on determining that the electronic device leaves the zone, performing a scan to change the RAT to the first RAT based on cell frequency information of the first RAT.

14. The operating method of claim 13, further comprising based on determining that the electronic device enters the zone, stopping the scan until the electronic device leaves the zone.

15. The operating method of claim 13, wherein the AI model is executed through at least one communication processor (CP) of the electronic device.

16. The operating method of claim 13, further comprising:
based on the RAT being changed from the first RAT to the second RAT, storing the cell frequency information of the first RAT, and
deleting or maintaining the cell frequency information based on whether the electronic device enters the zone, which is determined based on the AI model.

17. The operating method of claim 13, wherein the AI model is configured to determine whether the electronic device enters the zone and whether the electronic device leaves the zone based on a pattern indicated by at least one quality indicator in the information.

18. The operating method of claim 17, wherein the pattern comprises a first pattern based on an instantaneous value of the at least one quality indicator or a second pattern based on a differential value of the at least one quality indicator.

19. The operating method of claim 13, wherein the AI model is configured to receive sensor data from at least one sensor and configured to determine whether the electronic device enters the zone and whether the electronic device leaves the zone based on the information and the sensor data.

20. A non-transitory computer-readable storage medium storing one or more programs comprising instructions that, when executed by a processor, cause the processor to perform the operating method of claim 13.
